(19) United States
(12) Patent Application Publication
(10) Pub. No.: US 2015/0324934 A1
(43) Pub. Date: Nov. 12, 2015

(54) Management system for injection press molding problems

(71) Applicant: INGLASS S.P.A., San Polo Di Piave (TV) (IT)

(72) Inventors: Fabio MAZZOCCO, San Polo di Piave (TV) (IT); Marco Polesello, San Polo di Piave (TV) (IT)

(21) Appl. No.: 14/704,978

(22) Filed: May 6, 2015

(30) Foreign Application Priority Data
May 9, 2014 (IT) TV2014A000069

(51) Int. Cl. G06Q 50/04; G06F 3/0484; G06Q 10/06; G06F 3/0482

(52) U.S. Cl. CPC G06Q 50/04; G06F 3/0482; G06F 3/04842; G06Q 10/0635

(57) ABSTRACT

A method executed by a programmable unit (34) to reduce the time to repair defects or stoppages is described which manages a defect identified in a molding process (10) of an injection press (11) for plastic materials.

The method has phases for:
I. acquiring input about the defect;
II. searching a database (40) of technical causes to define a subset of causes relating to the defect acquired in step I;
III. reducing the number of causes by filtering from the subset only those compatible with the current work programme and/or the characteristics of the process;
IV. if the subset contains more than one cause, acquiring additional data about the defect and, on the basis of this data, discarding the causes in the subset that cannot be attributed to the defect;
V. displaying a list containing the technical solutions for the remaining causes in the subset, which will be shown in order of the statistical occurrence of the causes.

The invention refers to a management system for problems related to molding or malfunctions of an injection press and/or its components (e.g. the heater, the mold, etc.).

Currently, when a problem or a stall occurs during the molding process in an injection press, an expert is needed to assess the problem and suggest what action to take to eliminate the cause. Unfortunately, the skill and experience of a technician is not always on-hand or sufficient, or there may be a risk that not all the possible causes or information are properly taken into account.

Moreover, there are inevitable delays before the expert can intervene due to a lack of information received or a backlog of work that means he is busy elsewhere.

Thus, the need arises to help not only the person operating the press or the support technician, but also to gather specific information or solutions about all the problems as they occur and are solved.

The object, therefore, is to overcome one or more of these problems with a management method as indicated in the attached claims in which the dependent ones list advantageous variants.

A press on which the method can be implemented and a group of presses controlled remotely by the same method are also proposed.

The inventive concept envisages a method executed by a programmable unit to manage the defect detected in a molding process of an injection press for plastic materials including the steps for:
I. acquiring an input about the defect (e.g. acquired by reading the data input by a user from a user-interface or detecting it directly from the sensors):
II. searching a database of technical causes to define a subset of causes relating to the defect acquired in step I;
III. reducing the number of causes by filtering out from the subset only the ones compatible with the current work programme of the press and/or the characteristics (e.g. structural) of the process (there is no limitation to the sole characteristics of the press, but also those for the whole process by examining the type and/or the state of the product, the plastic material, the mold, the hot-runner and the press on which the process is carried out);
IV. if the subset contains more than one cause, acquiring additional data about the defect (see, for example, the options mentioned in step I) and, on the basis of this data, discarding the causes of the subset that cannot be attributed to the defect;
V. displaying (e.g. on a user-interface) a list containing technical solutions to the remaining causes in the subset, the list being ordered according to the statistical occurrence of the causes.

The method allows to quickly find a solution to the current problem and the press, which is at a standstill, can be re-activated, In particular, statistical sorting of the data into one or more phases minimizes both the machine downtime and the computational resources of the system.

Preferably, in step I text input by an operator or his selection from a list or menu of likely causes or defects can be read.

Advantageously in step I a number of successive inputs can be acquired from the user-interface with which to form a more accurate search key for step II. The aim is to increase the number of conditions with which to cross-check the data read from the databases for a quicker convergence on the current problem and solution.

Advantageously in step IV the user can be asked a specific question selected from a database of questions by means of correlation with the causes present in the subset, and an answer input can then be read from the user interface. Also, the aim is to lower the convergence time for the calculation and user operation for the current problem and solution.

In the same way, preferably:
the question deals with a process parameter, selected from a database of parameters through correlation with causes present in the subset and/or
in step IV, an experimental test is displayed to the user to be carried out on the press, the test being selected from a database of tests through correlation with the causes present in the subset, and an answer input about the result of the test performed is then read from the user interface.

Advantageously, to further improve the response time of the system, in step IV an output to be presented to the user is selected from a display starting from the causes with the highest statistical occurrence.

Preferably, in step I inputs about the defect are received from a remote terminal installed on the press. This is the case when a central management server reads the data from presses installed elsewhere, when the programmable unit is remotely located with respect to the press or group of presses.

Advantageously, to increase automation, if in step V there is only one solution, in a database of operational parameters of the press that a parameter can be searched that is indexed by the solution and the operation of the press is configured based on that parameter. Note that one can search not only for a parameter of the process but also for indications for maintenance/repair which the operator will then perform manually.

Preferably, the user input and/or output for each step can be stored in database so that the statistical and/or historical distribution of the data can be analysed and the system response times can be lowered in the next cycle.

The advantages of the method are that it is immediate, interactive and does not require any special skills.

An injection molding press is also proposed which is adapted to implement the method and is in particular equipped with means adapted to carry out the previously mentioned phases of the method.

The press can comprise
a user-interface for acquiring an input about a defect;
a processing unit for performing a search in a database of technical causes to define a subset of causes related to the acquired defect, the unit being configured to
   a. lower the number of causes by filtering from the subset only the compatible ones with the current work program of the press and/or the characteristics (e.g. structural) of the process, and
   b. if the subset contains more than one cause, acquire other data about the defect; and
   c. display on the user interface a list containing technical solutions to the residual causes in the subset, the list being ordered according to the statistical occurrence of the causes.

The press can comprise a device or means for carrying out each step of the method or variant of its as described.

A group of injection mold presses controlled externally according to the method is also proposed. In particular, a system comprising:
a group of presses for injection molding;
a user interface to acquire an input about a defect which occurred in a press in the group;
a processing unit, remote and external to the presses, for carrying out a search in a database of technical causes to define a subset of causes related to the defect acquired, the unit being configured to
   a. lower the number of causes by filtering from the subset only those causes compatible with the current work program of the press and/or the characteristics (e.g. structural) of the working process, and
   b. if the subset contains more than one cause, acquire other data about the defect; and
   c. display on the user interface a list containing technical solutions to the residual causes in the subset, the list being ordered according to the statistical occurrence of the causes.

The system can comprise a device or means to carry out each step of the method or variant of its as described.

The advantages of the invention will become clearer in the following description of a preferred embodiment of system, wherein reference is made to the attached diagram in which

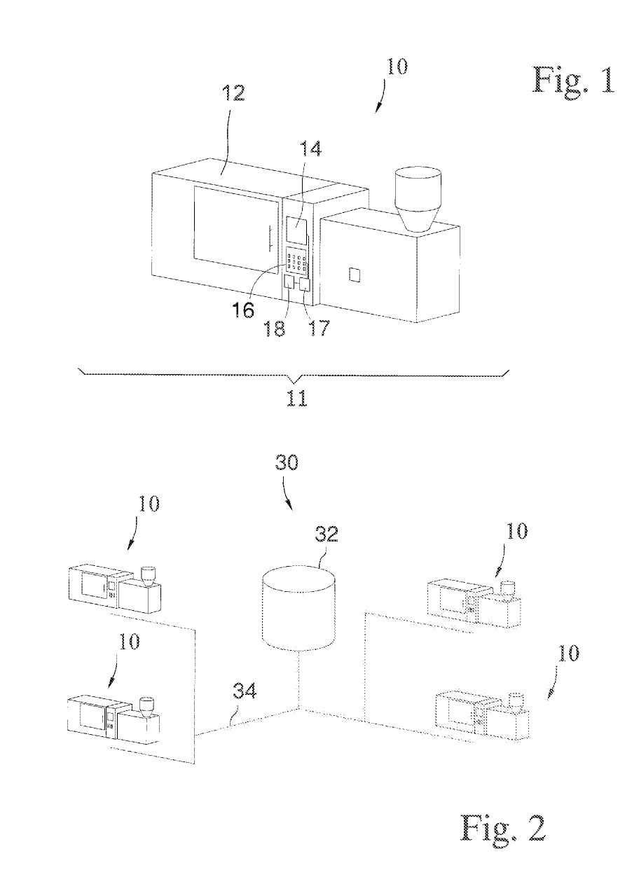

FIG. 1 shows an injection press,

FIG. 2 shows a management system for some injection presses,

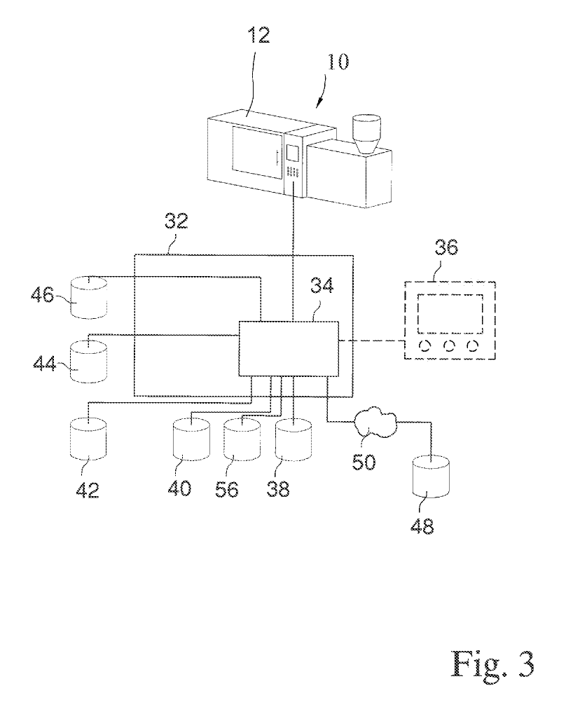

FIG. 3 shows a block diagram of the architecture of the system in FIG. 2.

In the figures, identical numerical references indicate same elements. FIG. 2 shows a system 30 for handling stalls and/or the solution of problems in molding plastic materials, and in particular for processes comprising a work island or equipment 10 (FIG. 1) adapted for producing a molded piece. The work island 10 comprises for the aim a hot-runner injection press 11 fitted with a known injection and molding assembly 12 which, in turn, comprises the functional units for plasticizing, injection and clamping. The assembly 12 can be controlled and programmed though a control terminal having a processor 17 that manages a display 14 and a keypad 16 and which can exchange data with a memory 18 of operating parameters for the press 11.

The press 11 in the work island 10 is generally the only part equipped with a terminal.

The architecture of the system 30 can be distributed on a network (FIG. 2) wherein a server or central computer 32 is connected by lines 34 to various work islands 11 to control and exchange data with them.

The server 32 (FIG. 3) is equipped with a processing unit 34 (e.g. a programmable microprocessor) on which a program is run which performs the steps of the method described below.

Unit 34 is interfaced with
(optionally) a display 36 to display signals or warnings for a user and a keypad 52 for receiving input;
a first database 38 containing a set of numerical or string data representing a collection of technical problems for the press 11;
a second database 40 containing a set of numerical or string data representing a collection of technical causes associated with one or more problems present in the database 38;
a third database 42 containing a set of numerical or string data representing a collection of technical tests;
a fourth database 44 containing a set of numerical or string data representing a collection of technical solutions;
a fifth database 46 containing a set of numerical or string data representing a collection of parameters of a press 11;
a sixth database 56 containing a set of numerical or string data representing the technical characteristics of the system 30 and/or of the mold and/or of the press 11 and/or of the work island 10;
a seventh database 58 containing a set of numerical or string data representing information about the working project in a work island 10 (e.g. plastic material currently used in the press 11, type of hot-runner, type of mold, press and characteristics of the molded piece);
a database or remote support centre 48, e.g. connected via Internet or Intranet network 50, containing a set of numerical or string data input in real time by a remote user;
one or more work islands 10 in order to exchange data with their displays 14 or keypads 16 or set the operating parameters thereof,

The database 58 contains specific data for each project while all the other databases contain non-specific data, or a collection of general data for all the projects and/or a collection of data from previous projects,

Please note that in an alternative embodiment, the press 11 could be connected via Internet or Intranet to the server 32 while the database 48 could be instead a terminal or a database adapted to receive or collect help requests.

Operation

Each of the steps described is intended to be carried out by the program in the unit 34.

On (very) rare occasions, it is thinkable that the system 30 may already have all the information at disposal and immediately provides the cause and the solution. When this does not happen, the system emits specific questions and requests specific tests. Hence, the system 30 shows to the user, e.g. by means of the display 14, a series of possible tests to quickly and correctly determine the cause of the stall and/or problem, and then one or more solutions as a function of the previous tests, in a rapid and guided manner.

The method is a guided procedure to the analysis/solution of a technical problem occurred during the molding process in a press 11.

When a person works on or supervises a press 11 or a work island 10, he is asked by the display 14 or 36 if he is going to intervene on a problem or stall.

Step 1—Collecting Information

This step is comprised of the definition of the technical problem that led to the a stall or a defect.

The problem can be directly accepted by the system 30 by reading the input from the keypad 16 of the operator or a predefined list of problems with a selection option is automatically shown on the display 14 by accessing the data of the database 38, or else, the display 14 allows a search in database 38 to be carried out by a keyword or by a collection of images which may optionally be filtered according to specific criteria. These criteria may be associated, for example, with the technical characteristics of the project (e.g. with the particular type of molded piece, the plastic material, the gate configuration, etc.). Also, as a variant the system 30 can suggest the problem based on sensors linked to the management of the press 11. For example, if the injection pressure (data normally present and monitored by the press 11) differs with respect to a “normal” value, this could be automatically detected by the system 30 and/or prompted to the operator with a message on the display 14.

if the problem is not easy to define or not included in the database 38, the server or remote center 48 can be accessed, for example, because it is connected to another operator.

When the problem has been properly defined, a second step starts in which the causes thereof are defined,

Step 2—Definition of Causes

The database 40 of technical causes is accessed and data associated with or identifying a particular problem (found in the previous step in the database 38 or manually input) is searched for, and a filter automatically extracts the relevant data on possible causes from database 40.

The display 14 then shows the list of possible causes which can also be ordered by the unit 34 according to a statistical occurrence. The number of statistical occurrences can be a data saved in the database 40 or calculated in real time by the unit 34.

A series of tests to be carried out on the press 11 and/or requests for specific information not (yet) present in the parameters of the machine or in the databases are shown on the display 14 for every possible cause. The list of tests, of specific information and of expected results are stored in the database 42 which is consulted with an indexed search.

The results of these tests are carried out manually by the user or to the press 11 commands are sent by the control unit 34 to carry out internal diagnostic tests.

The specific information and/or the results of the tests, obtained from the keypad 16 after manual input by the user or automatically detected on the press 11 by the unit 34 through sensors (not shown) or by reading and/or scanning the database 56 are, in turn, input into the filter of causes until a single cause of the problem being analysed is determined.

Step 3—Solution to the Problem

The unit 34 searches in the database 44 for one or more solutions to the problem associated to a particular cause and shows them to the operator on the display 14.

The operator either acts upon instruction of the unit 34 on the display 14 or the unit 34 receives input from the operator by the keypad 16 about the solution to be implemented. Thus, the unit 34 searches in the database 46 the parameters associated with the chosen solution and with them it can configure the stalled press 11, updating them in the memory 18, to restart operation thereof. Alternatively, advantageously, the data in the database 46 can be “ideal” data that the unit 34 compares with those actually received from the press 11 and/or the operator to determine if the cause is due to incorrect settings. If the unit 34 recognises a cause, then the solution is to copy the correct data contained in the database 46 into the memory 18.

Some example parameters are
optimal process parameters associated with the specific project and stored in the database 46 in the course of previous iterations;
injection profiles (derived from Moldflow simulations, for example) related to the mold/hot-runner being used on the press 11 under investigation;
the optimal temperatures of the plasticising cylinder and/or of areas of the hot-runner.

The data in the solutions database 44 can also be classified by statistical occurrence.

If the implementation of the solutions goes well and solves the problem, all the relevant information about the case (from the problem to the solution) are preferably collected for statistical purposes and historical records relating to the specific press, mold, hot-runner, customer or other characteristics. In particular, the databases 38 and/or 40 and/or 42 and/or 44 and/or 46 are updated with the new collected data.

If the identified solution does not effectively solve the problem or if other defects are detected, it is possible to restart the process from step 1 or the remote server 48 can be contacted for support for example by another operator.

One of the advantages of the method is to limit the number of intervention requests to the server or support centre 48 or, in any case, to the most experienced and qualified technical personnel.

If an intervention request is made to the server 48, the system 30 automatically prepares a complete summary of all the information collected and all the tests carried out, saving them in the databases 38 and/or 40 and/or 42 and/or 44 and/or 46 in order to keep any possible delays and lack of information to a minimum.

The function of the server or support centre 48 is to analyse all the problems (causes or solutions) which have not already been handled by the system 30, assess and investigate them, for example, with other company departments and populate with new definitions and/or data the databases 38 and/or 40 and/or 42 and/or 44 and/or 46.

The classification and statistic sorting system has the goal to classify the data in the databases 38 and/or 40 and/or 42 and/or 44 and/or 46 based for example on the type of press 11, and/or its components (e.g. using their production date and wearing time as a sorting parameter), the type of project under way and/or the customer.

The system 30 could, thus, also handle any improvements in the molded product from a press 11, caused by specific problems and highlighted by statistical analysis, and by inputting data into the databases 38 and/or 40 and/or 42 and/or 44 and/or 46, it could suggest the renewal of obsolete components as a solution.

The system 30 can be also be accessed from the control terminal of a press 11, so that all the information, data or actions can be directly collected on and from the press 11, either manually or automatically, through interaction between the terminal 17 and the unit 34 which saves and searches for data in the databases 38 and/or 40 and/or 42 and/or 44 and/or 46.

The system 30 could bind the modification of the parameters saved locally on a press 11, so that the operator can modify them only by consulting and being guided by the system 30, or only after a guided solution of a problem. Essentially, any modifications to the data in the database 44 and/or the memory 18 must be authorized by the unit 34.

It should be noted that even a stand-alone press 11 which is isolated from the outside can be equipped with a system like the system 30. Connection to an external data network is lost, but however a press so built can still continuously store inside itself data about stalls or malfunctions and use it to instruct an operator and/or for an automatic reset.

One can understand that the system 30 also has, among other things, the advantages of
preserving company know-how in digital form for use by all operators;
solving problems of stalls or malfunctions without performing trial-and-error tests or while keeping them to a minimum (reduced costs for machine down-time and less waste);
providing a statistical analysis for every mold/press/period relating to the causes which result in waste and problems. Not only is the system or search algorithm for the problem much faster, but time and costs for machine down-time, the power consumed by the system 30 when it is brought into play and the information processing time for user display, are all reduced (the response arrives in shorter time);
the presses 11 become increasingly more intelligent because the system 30 can learn from previous problems that have been solved.

1. Method executed by a programmable unit (34) to manage a defect detected Ina molding process (10) of an injection molding press (11) for plastic materials, comprising the steps of
I. acquiring an input relative to the defect;
II. performing a search in a database (40) of technical causes to define a subset of causes relating to the defect acquired in step I;
reducing the number of causes by filtering from the subset only those compatible with the current work program and/or the characteristics of the process;
IV. if the subset contains more than one cause, acquiring other data related to the defect and on the basis of these data discarding the causes of the subset not attributable to the defect;
V. showing a list containing technical solutions to the residual causes in the subset, the list being ordered according to the statistical occurrence of causes.

2. Method according to claim 1, wherein in step I the acquisition takes place by reading from a user-interface (14, 16) data entered by a user or his selection from a list or menu of causes or probable defects, or by directly detecting sensors.

3. Method according to claim 2, wherein in step I a plurality of subsequent inputs are acquired from the user-interface to form a more precise search key for step II.

4. Method according to claim 1, wherein in step I a plurality of subsequent inputs are acquired from the user-interface to form a more precise search key for step II.

5. Method according to claim 3, wherein in step IV the user is presented with a specific question, selected from a database of questions (38) by means of correlation with the causes present in the subset, and from the user interface a response input is read.

6. Method according to claim 5, wherein in step IV □
the user is presented an experimental test to be performed on the press, the test being selected from a database of tests (42) by means of correlation with the causes in the subset, and
from the user interface a response input is read relative to the result of the test performed.

7. Method according to claim 6, wherein in step IV an output to be presented to the user is selected starting from the causes with greater statistical occurrence.

8. Method according to claim 1, wherein if in step V there is only solution, a parameter indexed by the solution is searched in a database of operational parameters (46) of the press and the operation of the press is configured according to that parameter.

9. Method according to claim 7, wherein if in step V there is only solution, a parameter indexed by the solution is searched in a database of operational parameters (46) of the press and the operation of the press is configured according to that parameter.

10. Method according to claim 1, wherein the user inputs and/or the outputs of the unit relative to each phase are stored in database, in order to analyze the statistical and/or historical distribution of the data during the next cycle.

11. Method according to claim 9, wherein the user inputs and/or the outputs of the unit relative to each phase are stored in database, in order to analyze the statistical and/or historical distribution of the data during the next cycle.

12. Press (11) for injection molding comprising:
a user-interface (14, 16) to acquire an input relating to a defect;
a processing unit (17) to perform a search in a database (40) for technical causes to define a subset of causes relating to the acquired defect, the unit being configured to
a) reduce the number of causes by filtering from the subset only those compatible with the current work program of the press and/or the characteristics of the process, and
b) if the subset contains more than one cause, acquire other data related to the defect; and
c) show on the user interface a list containing technical solutions to the residual causes in the subset, the list being ordered according to the statistical occurrence of the causes.

13. System (10) comprising:
a group of presses (11) for injection molding;
a user-interface (14, 16, 36) to acquire an input relative to a defect occurring in a press of the group;
a processing unit (34), external to the presses and remote, to perform a search in a database (40) of technical causes to define a subset of causes relating to the acquired defect, the unit being configured to
a) reduce the number of causes by filtering from the subset only those compatible with the current work program of the press and/or the characteristics of its manufacturing process, and
b) if the subset contains more than one cause, acquire other data related to the defect; and
c) show on the user interface a list containing technical solutions to the residual causes in the subset, the list being ordered according to the statistical occurrence of the causes.
